(19) United States
(12) Patent Application Publication
(10) Pub. No.: US 2023/0097841 A1
(43) Pub. Date: Mar. 30, 2023

(54) ATMOSPHERE LAMP FOR MASSAGE TABLE

(71) Applicant: Jiangsu Mingteng Health Products Co., Ltd, Yancheng (CN)

(72) Inventor: Chuankui Du, Jinshan (CN)

(73) Assignee: Jiangsu Mingteng Health Products Co., Ltd, Yancheng (CN)

(21) Appl. No.: 18/073,575

(22) Filed: Dec. 2, 2022

(30) Foreign Application Priority Data
Sep. 15, 2022 (CN) 202222463607.6

(51) Int. Cl. F21S 4/28; F21V 23/06; F21V 21/08; F21V 23/04; F21S 2/00

(52) U.S. Cl. CPC F21S 4/28; F21V 23/06; F21V 21/08; F21V 23/04; F21S 2/005

(57) ABSTRACT

The present disclosure is applicable to the technical field of massage apparatuses, and provides an atmosphere lamp for massage table. The atmosphere lamp includes at least two light-emitting units, each of which includes a light strip, a fixed strip, and end fixing members; the light strip is arranged in the fixed strip and is clamped by the fixed strip; one end fixing member is mounted at each of two ends of the fixed strip; the end fixing members are provided with DC connection terminals; the atmosphere lamp further includes a light-emitting unit connection wire; two ends of the light-emitting unit connection wire are provided with DC connection terminals; the plurality of light-emitting units are connected through the light-emitting unit connection wires; the atmosphere lamp further includes a power adapter.

### TECHNICAL FIELD

The present disclosure relates to the technical field of massage apparatuses, specifically to an atmosphere lamp for massage table.

### BACKGROUND

Massage, facial and private health clubs have become popular normal health care places in people's life, which can be seen everywhere in almost all big cities. However, massage tables in these places often have simple styles, which are usually composed of a rigid planner surface, sponge and an upholstery cover, and arranged in private rooms of massage places. A private room is generally dark, so that some atmosphere lamps are additionally arranged in a massage place during decoration to enhance a delightful atmosphere of the private room. However, this usually causes a high decoration cost. Therefore, the designer of the present disclosure hopes to provide an atmosphere lamp that can be easily mounted below the rigid planner surfaces of massage tables, so that a massage atmosphere can be quickly created and improved without spending high decoration cost for the massage place.

### SUMMARY

An embodiment of the present disclosure is to provide an atmosphere lamp for massage table, and aims to help a massage place to rapidly create and improve a light atmosphere for massage and save the decoration cost. Sectioned light sources are connected through soft wires and can be conveniently mounted below rigid planner surfaces of massage tables in different sizes and structures.

The present disclosure is achieved by an atmosphere lamp for massage table, including light-emitting units.

Each light-emitting unit includes a light strip, a fixed strip, and end fixing members; the fixed strip is made of a rigid material and has a U or C-shaped section; a cross section of the light strip is matched with a U or C-shaped gap structure of the fixed strip; the light strip is arranged in the U or C-shaped gap of the fixed strip and is clamped by the fixed strip; the end fixing members are mounted at two ends of the fixed strip; the end fixing members are provided with DC connection terminals; two ends of the light strip are respectively electrically connected to the DC connection terminals arranged on the end fixing member; a working current of the light strip is a direct current lower than 36 voltage; and the light strip may emit light when a current is made to the light strip.

In a further technical solution, at least two light-emitting units are arranged, each of which has a length not greater than 90 cm.

In a further technical solution, the atmosphere lamp further includes a light-emitting unit connection wire; two ends of the light-emitting unit connection wire are provided with DC connection terminals; the DC connection terminals at the two ends of the light-emitting unit connection wire are movably connected to the DC connection terminals of the end fixing members of the light-emitting unit; and a plurality of light-emitting units are connected through the light-emitting unit connection wires.

In a further technical solution, the atmosphere lamp further includes a power adapter used for converting a voltage of an external power supply of 110-230 V to a safe voltage lower than 36 V.

In a further technical solution, the atmosphere lamp further includes a control unit; the control unit includes a circuit board, a control switch, and a control unit wire; the control switch is connected and communicates with the circuit board; one end of the control unit wire is connected to the circuit board, and the other end of the control unit wire is provided with a DC connection terminal; the DC connection terminal at the end of the control unit wire is movably connected to the DC connection terminals of the end fixing members of the light-emitting unit; and the circuit board supplies power to the light-emitting unit through the control unit wire.

In a further technical solution, the power adapter is connected to the circuit board in the control unit through a wire, and the power adapter supplies power to the circuit board.

In a further technical solution, the circuit board controls the light-emitting brightness and color of the light strip by means of controlling supplied current or voltage.

Compared with the prior art, the present disclosure has the beneficial effects:

The atmosphere lamp for massage table provided according to the present disclosure can be mounted below a rigid planner surface of the massage table. A user turns on the light strip of the light-emitting unit through the control unit, and controls the light-emitting brightness and light-emitting color of the light strip through the control unit. The user can feel warm, comfortable and relaxed when entering a massage room, and has a better massage feeling.

### BRIEF DESCRIPTION OF THE DRAWINGS

FIG. 1 is a schematic diagram of a finished product of an atmosphere lamp for massage table provided in Embodiment 1 of the present disclosure;

FIG. 2 is an exploded diagram of an atmosphere lamp for massage table provided in Embodiment 1 of the present disclosure;

FIG. 3 is a schematic diagram 1 of mounting an atmosphere lamp for massage table provided in Embodiment 1 of the present disclosure; and

In the drawings: light-emitting unit 1, light strip 2, fixed strip 3, end fixing member 4, light-emitting unit connection wire 5, power adapter 6, control unit 7, circuit board 8, massage table 9, control switch 10, and control unit wire 11.

### DETAILED DESCRIPTION OF THE EMBODIMENTS

In order to make the objectives, technical solutions and advantages of the present disclosure clearer, the present disclosure is further described in detail below with reference to accompanying drawings and embodiments. It should be understood that the specific embodiments described here are merely to illustrate and explain the present disclosure, and not intended to limit the present disclosure.

Specific implementation of the present disclosure is described in detail below in combination with specific embodiments.

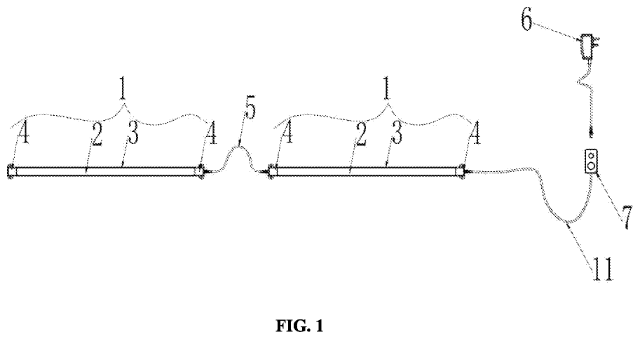

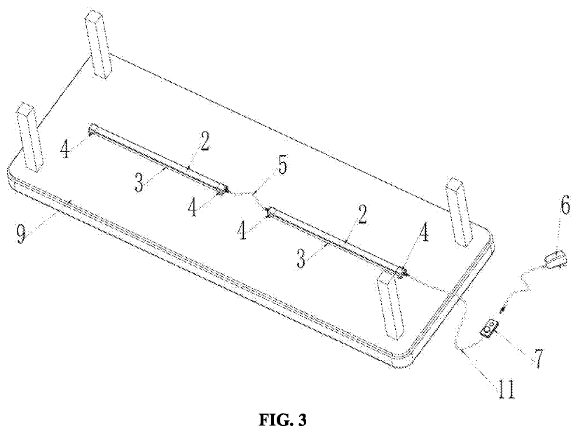

As shown in FIG. 1 to FIG. 3, an atmosphere lamp for massage table provided according to one embodiment of the present disclosure includes a light-emitting unit 1, a light strip 2, a fixed strip 3, and end fixing members 4. The light-emitting unit 1 includes the light strip 2, the fixed strip 3, and the end fixing members 4. The fixed strip 3 is made of an aluminum alloy profile and has a U or C-shaped section. The light strip 2 is in a long strip shape, a cross section of which is matched with a U or C-shaped gap structure of the fixed strip 3. The light strip 2 is arranged in the U or C-shaped gap of the fixed strip 3 and is clamped by the fixed strip 3. The end fixing member 4 is mounted at each of two ends of the fixed strip 3. The end fixing members 4 are provided with DC connection terminals. The DC connection terminals arranged on the end fixing members 4 are female terminals.

As shown in FIG. 1 to FIG. 3, the atmosphere lamp for massage table provided according to one embodiment of the present disclosure further includes a light-emitting unit connection wire 5. Two ends of the light-emitting unit connection wire 5 are provided with DC connection terminals. The DC connection terminals at the two ends of the light-emitting unit connection wire 5 are male terminals.

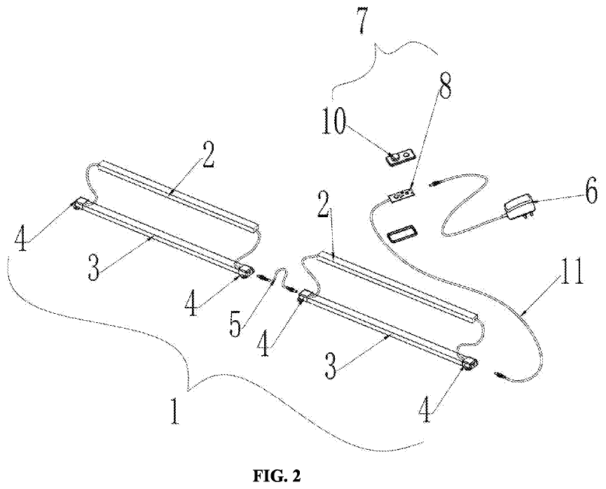

As shown in FIG. 1 to FIG. 2, there are two light-emitting units 1. Each light-emitting unit 1 has a length of 70 cm. The two light-emitting units 1 are connected through the light-emitting unit connection wire 5. The male DC terminals at the two ends of the light-emitting unit connection wire 5 are respectively connected to the female DC terminal at one end of the first light-emitting unit 1 and the female DC terminal at one end of the second light-emitting unit 1.

In the embodiment of the present disclosure, the light-emitting unit connection wire 5 is made of a soft wire material. It can effectively avoid and bypass an obstacle when there is a crosspiece, a folding structure and a table leg below a rigid planner surface of the massage table 9.

In the embodiment of the present disclosure, a working voltage of the light strip 2 is direct current power lower than 36 voltage. The light strip 2 can emit light when a current is made to the light strip 2. A higher current causes the light strip 2 to have higher light-emitting brightness.

As shown in FIG. 1 to FIG. 3, the atmosphere lamp further includes a control unit 7, a circuit board 8, a control switch 10, and a control unit wire 11. The control switch 10 is connected and communicates with the circuit board 8. One end of the control unit wire 11 is connected to the circuit board 8, and the other end of the control unit wire 11 is provided with a male DC connection terminal. The male DC connection terminal at the end of the control unit wire 11 is movably connected to the female DC connection terminal of the end fixing member 4 of the light-emitting unit 1. The circuit board 8 supplies power to the light-emitting unit 1 through the control unit wire 11.

In the embodiment of the present disclosure, the circuit board 8 supplies power to the light-emitting unit 1 to make the light strip 2 to emit light. The circuit board 8 stops supplying power to the light-emitting unit 1 to stop the light strip 2 from emitting light. The circuit board 8 controls the light-emitting brightness and color of the light strip 2 by means of controlling the current.

In the embodiment of the present disclosure, the circuit board 8 pre-stores a working program. A user sends an instruction to the circuit board 8 by operating the control switch 10. The circuit board 8 supplies or cuts off power to the light-emitting unit 1 or adjusts the current according to the instruction, thus controlling the light-emitting brightness and color of the light strip 2.

As shown in FIG. 1 to FIG. 3, the atmosphere lamp further includes a power adapter 6. The power adapter 6 is connected to an external power socket. The power adapter 6 is connected to the circuit board 8 in the control unit 7 through a wire. The power adapter 6 supplies power to the circuit board 8, and can convert a voltage of an external power supply of 110-230 V to a safe voltage lower than 36 V, so as to avoid an electric shock risk caused by a strong current to users.

In the embodiment of the present disclosure, a user connects the power adapter 6 to the external power socket. The power adapter 6 converts the external voltage of 110-230 V to the safe voltage lower than 36 V and supplies the current to the circuit board 8 in the control unit 7 through the wire. The control unit 7 is provided with the control switch 10. The control switch 10 is connected to the circuit board 8, so that the control switch 10 is operated to control the circuit board 8. The circuit board 8 of the control unit 7 supplies power to the light-emitting unit 1 through the wire, so that the light strip 2 of the first light-emitting unit 1 emits light. The first light-emitting unit 1 is electrically connected to the second light-emitting unit 1 through the light-emitting unit connection wire 5, so that the light strip 2 of the second light-emitting unit 1 emits light. The user controls the light-emitting brightness and color of the light strip 2 by means of operating the control switch 10.

The above descriptions are only the preferred embodiments of the present disclosure, and are not intended to limit the present disclosure. Any modifications, equivalent replacements and improvements that are made within the spirit and principle of the present disclosure shall fall within the protection scope of the present disclosure.

What is claimed is:

1. An atmosphere lamp for massage table, comprising a light-emitting unit,
wherein the light-emitting unit comprises a light strip, a fixed strip, and end fixing members; the fixed strip is made of a rigid material and has a U or C-shaped section; a cross section of the light strip is matched with a U or C-shaped gap structure of the fixed strip; the light strip is arranged in the U or C-shaped gap of the fixed strip and is clamped by the fixed strip; the end fixing members are mounted at two ends of the fixed strip; the end fixing members are provided with DC connection terminals; two ends of the light strip are respectively electrically connected to the DC connection terminals; and a working current of the light strip is a direct current lower than 36 voltage.

2. The atmosphere lamp for massage table according to claim 1, wherein at least two light-emitting units are arranged.

3. The atmosphere lamp for massage table according to claim 1, further comprising a light-emitting unit connection wire; two ends of the light-emitting unit connection wire are provided with DC connection terminals; the DC connection terminals at the two ends of the light-emitting unit connection wire are movably connected to the DC connection terminals of the end fixing members of the light-emitting unit; and a plurality of light-emitting units are connected through the light-emitting unit connection wires.

4. The atmosphere lamp for massage table according to claim 1, further comprising a power adapter used for converting a voltage of an external power supply of 110-230 V to a safe voltage lower than 36 voltage.

5. The atmosphere lamp for massage table according to claim 1, further comprising a control unit, wherein the control unit comprises a circuit board, a control switch, and a control unit wire; the control switch is connected and communicates with the circuit board; one end of the control unit wire is connected to the circuit board, and the other end is provided with a DC connection terminal; the DC connection terminal on the control unit wire is movably connected to the DC connection terminals of the end fixing members of the light-emitting unit; and the circuit board supplies power to the light-emitting unit through the control unit wire.

6. The atmosphere lamp for massage table according to claim 4, wherein the power adapter is connected to the circuit board in the control unit through a wire, and the power adapter supplies power to the circuit board.

7. The atmosphere lamp for massage table according to claim 1, wherein the circuit board controls a light-emitting brightness and color of the light strip by means of controlling a current or voltage.
